(19) United States
(12) Patent Application Publication
(10) Pub. No.: US 2016/0273701 A1
(43) Pub. Date: Sep. 22, 2016

(54) Four Legged Bases For Supporting Objects

(71) Applicant: Stackable Tables Pty Ltd., Eagle Bay, Western Australia (AU)

(72) Inventors: Christopher Brian HEYRING, Eagle Bay (AU); Toby William HEYRING, Eagle Bay (AU); Richard MONK, Yalyalup (AU)

(21) Appl. No.: 15/033,909

(22) PCT Filed: Nov. 7, 2014
(86) PCT No.: PCT/AU2014/050341

§ 371 Date: May 3, 2016

(30) Foreign Application Priority Data
Nov. 7, 2013 (AU) 2013904311

(51) Int. Cl. F16M 11/22; A47B 13/02; F16M 11/28; A47B 3/00

(52) U.S. Cl. CPC F16M 11/22; A47B 3/00; A47B 13/023; F16M 11/28; F16M 2200/08; A47B 2013/024; A47B 2013/026

(57) ABSTRACT

A stackable base (1) for supporting an object (not shown) via a hub 2 has four legs (3-6) extending from the hub. Each leg is perpendicular in plan view to the two adjacent legs, and is also offset from the leg on the opposite side of the hub. Each leg is also angled downwards as it projects from the hub. This construction allows two such bases (1,1a) to be horizontally stacked. The top outer edge of the legs can be shaped to sweep downwards to increase the clearance to the perpendicular leg of an adjacent base of similar design. Similarly the lower edge of the hub can be cut away or shaped to increase the clearance to the top surface of a leg of an adjacently stacked base.

### FIELD OF THE INVENTION

The present invention is generally directed to support stands and bases and in particular to four-legged nesting support stands or bases for supporting objects such as signs, speakers, foldable table tops and medical equipment.

### BACKGROUND OF THE INVENTION

There are known many different designs of pedestal type stands and bases for supporting a variety of objects such as temporary signs, surround sound speakers, medical equipment and foldable table tops (foldable between an operating position in use and a storage position).

Generally, the base portion of such stands does not permit the legs of one base to overlap or pass under or over legs of a similar base when two such bases are stored close together. This limits how closely the bases can be positioned horizontally when multiple bases are stored together and results in the stored bases taking up large amounts of storage space.

### BRIEF DESCRIPTION OF KNOWN ART

U.S. Pat. No. 3,182,613 shows a cluster of tables that can be closely stacked. The table tops include slots to permit the stem of a first table to be stacked to the stem of adjacent tables. In one arrangement the base is flat and also includes similar slots so that the bases of adjacent tables can be stacked on top of each other, offset both vertically and horizontally from adjacent bases. In an alternate arrangement the legs on a base have the same height as each other, but the height of legs is varied from one base to another allow the legs of one base to overlap or pass under or over the legs of an adjacent base. In both arrangements, the table top is slotted rather than solid which is very inconvenient and the number of bases that can be stacked together in one cluster is limited by the change in height from one base to the next.

U.S. Pat. No. 2,170,006 discloses a construction of support base having three legs radiating from a triangular central hub which forms webs between the legs. One of the legs is lower to the ground than the other two legs and the hub so that the lower leg of one base can pass under a leg or hub of an adjacent base to permit the bases to be horizontally stacked. However, a three legged base is not suitable for all applications, such as supporting a square table top where four legs are preferred to permit clear foot room for people sitting at the table. Also the stacking of multiple bases requires the lower leg of alternate bases to be oriented on opposite sides of the lower leg of each horizontally stacked base.

U.S. Pat. No. 6,662,731 discloses a four legged pedestal style base for a table having a foldable table top. Two adjacent legs have flattened cross-sections that lie closer to the ground than the opposite two higher legs so that they do not interfere with the higher legs of an adjacent horizontally stacked table. The lack of symmetry required by this arrangement of base to permit horizontal stacking and the flat profile of two of the legs is not as aesthetically pleasing as many conventional designs of support base. Also this horizontal stacking arrangement where two legs of a base must pass under one adjacent base and the other two legs must pass over another adjacent base limits the direction of horizontal stacking to one way only, i.e. each base must be oriented in the same way to stack together.

This may be acceptable where the base supports a folding table top or a sign board and the direction of stacking is already limited to one or two ways, but its lack of rotational symmetry can limit the application of this base arrangement.

International publication number WO2008/040034 shows a folding pedestal type base having an opposing pair of legs rising higher towards the hub than the other opposing pair of legs, i.e. the arrangement when in its operational position has 2-fold rotational symmetry. For storage, the base can either be folded by rotating one opposite pair of legs relative to the other pair of opposite legs and the stem so that the feet and the stem all lie in a vertical package space of minimal thickness, or the base can be horizontally stacked by sliding one of the lower legs of a first base alongside a lower leg of a second base and under a higher leg of the second base. However the lower legs cannot pass under the hub when stacking.

In the present specification, the phrase ‘horizontally stacked’ or the like is not to be taken as limiting to stacking in a precise horizontal plane or direction. ‘Horizontal stacking’ or the like refer to sideways or lateral direction stacking of the base(s) with at least one other such base having compatible stacking features to accommodate such stacking.

It would therefore be desirable to provide a base that overcomes one or more disadvantages of the known art.

### SUMMARY OF THE INVENTION

According to one aspect of the invention there is provided a horizontally stackable base to support an object, the base comprising: a hub connected to the object to be supported; four legs extending from the hub, each leg including a ground engaging portion, the four legs being a first, second, third and fourth leg, the first and third legs being on opposing sides of the hub and substantially perpendicular to the second and fourth legs, wherein the stackable base includes a leg geometry such that, when a first and second said stackable base are horizontally stacked, the first leg of the second stackable base passes under at least a portion of the hub and optionally under a region of a leg of the first stackable base and the third leg of the first stackable base passes under at least a portion of the hub and optionally under a region of a leg of the second stackable base.

For example, the hub may provide clearance to permit a portion of a leg to pass under the hub of an adjacent base thus the leg is permitted to pass under the hub between the hub and the ground. Alternatively or additionally at least the first and third legs may include at least one stepped portion lower than at least a region of the hub. Alternatively or additionally at least the first and third legs may include a stackable profile portion extending from a distal end towards the hub, the stackable profile portion being lower than at least a region of the hub and thus able to pass under the hub.

The ground engaging portion may, for example, be selected from one or more of at least one foot, at least one caster, at least one ground engaging point, or other ground engaging means. Each leg may include a hub end connected or fixed to or formed into the hub and a distal or foot end including the ground engaging portion.

For example, at least half of a length (i.e. from the distal end to the hub end of) of the first leg of the second stackable base may pass under the hub and optionally under a region of at least one leg of the first stackable base; and at least half of a length (i.e. from the distal end to the hub end of) the third leg of the first stackable base may pass under the hub and optionally under a region of at least one leg of the second stackable base. If just half of the length of the leg passes under part of an adjacent base, the nesting can be defined as having 50 percent engagement. Similarly, if three quarters of the length of the first leg of the second stackable base passes under the hub and/or under a region of a leg of the first stackable base and three quarters of the third leg of the first stackable base passes under the hub and/or under a region of a leg of the second stackable base, the magnitude of nesting can be defined as 75 percent engagement. For example, the limit to the engagement possible when stacking the bases (i.e. the minimum distance between the hubs of adjacent horizontally stacked bases) may be when a portion of the leg or hub of the first base contacts the hub of the second base, or when contact is made between the object supported by the first base and the object supported by the second base (or alternatively a stem supporting the object).

When a first and a second said stackable base are horizontally stacked the first leg of the second stackable base may be partially (i.e. for a portion of its length and for at least a portion of its width) under the first leg of the first stackable base, and the third leg of the first stackable base may be partially (i.e. for a portion of its length and for at least a portion of its width) under the third leg of the second stackable base. For example, a portion of the stackable profile portion of the first leg of the second stackable base is lower than a portion of the stackable profile portion of the first leg of the first stackable base; and a portion of the stackable profile portion of the third leg of the second stackable base is higher than a portion of the stackable profile portion of the third leg of the first stackable base.

The base may include or be connectable to at least one stem which is/are in turn connected to the object to be supported, the stem preferably having a primary axis.

Each leg may have a primary axis, the primary axis of the first and third legs may be offset by at least a width of the first or third leg or the primary axis of the first and third legs may be offset by at least a width of the/a stackable profile portion of the first or third leg. For example a plane parallel to the primary axis of the stem and coinciding with the inner edge of the first leg may be aligned with a plane parallel to the primary axis of the stem and coinciding with an inner edge of the third leg, or there may be a clearance between the first leg and a plane parallel to the primary axis of the stem and coinciding with an inner edge of the third leg.

Each leg may be angled, at for example a minimum of 10 degrees from a base plane, the base plane being a virtual plane passing through the ground engaging portion of each leg of the horizontally stackable base, such that when multiple of said horizontally stackable bases are horizontally stacked, an upper surface of the first leg of one base may be under a lower surface of the first leg of the adjacent base and an upper surface of the third leg of one base may be under a lower surface of the third leg of another adjacent base. The minimum angle of each leg from the base plane may for example alternatively be 7 degrees, preferably 8 degrees, more preferably 9 degrees and even more preferably 10 degrees. The maximum angle of each leg from the base plane may for example be 25 degrees, preferably 20 degrees, more preferably 17 degrees and even more preferably 15 degrees.

Alternatively, when the first and second of said stackable base are horizontally stacked the first legs of the first and second stackable bases may be arranged side-by-side, and the third legs of the first and second stackable bases may be arranged side-by-side.

Each leg may have a primary axis, the primary axis of the first and third legs being offset by at least a width of the first or third leg or the primary axis of the first and third legs may be offset by at least a width of the/a stackable profile portion of the first or third leg. Again, a plane that is perpendicular to the base plane and coinciding with an inner edge of the first leg may coincide with an inner edge of the third leg or have clearance to the third leg.

Alternatively or additionally, the hub may have a virtual axis extending substantially perpendicular to a base plane and passing through the centre of the hub, the base plane being a virtual plane passing through the ground engaging portion of each leg of the horizontally stackable base, the four legs having either 2-fold or 4-fold rotational symmetry about said virtual axis (i.e. if 4-fold, each of the four legs is substantially the same). Pairs of opposing legs may comprise one leg parallel to another leg, the one leg and the another leg being offset from the centre of the hub and from each other. For example, each leg may have a respective primary axis, the primary axis of the first leg may be parallel to the primary axis of the third leg, and the primary axes of the first and third legs may be offset from the centre of the hub (e.g. the virtual axis) and from each other. If the rotational symmetry is 4-fold then additionally, the primary axis of the second leg may be parallel to the primary axis of the fourth leg, and the primary axes of the second and fourth legs may be offset from the centre of the hub (e.g. the virtual axis) and from each other.

The object may be a table top connected to the hub by a stem. The table top may be foldable relative to the stem between an operating position (e.g. typically substantially horizontal or perpendicular to the stem) and a stacking or storing position (e.g. typically substantially vertical or substantially parallel to the stem).

A hub centre virtual axis may extend through the centre of the hub perpendicular to a base plane, the base plane being a virtual plane passing through the ground engaging portion of each leg of the horizontally stackable base. For example, the hub may have a hub centre virtual axis extending vertically at the centre of the hub when the ground engaging portions of the legs are in a common horizontal plane. The stem may have a major axis. The major axis of the stem may be aligned with the hub centre virtual axis.

Alternatively, the object may be a stand, such as for a sign board, medical equipment, etc.

One or more forms of the present invention may provide a horizontally stackable base to support an object above four legs, the stackable base including the four legs extending from a hub, the hub to be connected by a stem to the object to be supported, each leg including a ground engaging portion, the four legs being a first, second, third and fourth leg, the first and third legs being on opposite side of the hub and substantially perpendicular to the second and fourth legs. At least the first and third legs may each include a stackable profile portion extending a distance from a/the distal end of the respective leg (preferably adjacent or including the ground engaging portion of the respective leg), the stackable profile portion having a top surface lower than at least a region of the hub, such that when a first, a second and a third of said stackable bases are horizontally stacked, the stackable profile portion of the first leg of the second stackable base passes under the hub of the first stackable base, and the stackable profile portion of the third leg of the second stackable base passes under the hub of the third stackable base. For example, for any given base, only one leg passes under the next stackable base (if present) and only one (i.e. the opposite) leg passes under the previous stackable base (if present) in the horizontal stack of bases. Maximising the distance that the stackable profile portion extends along each first and third leg thereby enables the distance between the primary axes of the stems of the first and second stackable bases to be minimised (for example there can be less than 150 mm between the primary axis of each stem). Preferably the stackable profile portion extends at least 75%, more preferably 85%, and even more preferably 90% of the distance from the distal end of the respective leg to the hub.

When horizontally stacked, the first leg of the second stackable base may be partially under the first leg of the first stackable base and partially above the first leg of the third stackable base and the third leg of the second stackable base may be partially above the third leg of the first stackable base and partially under the third leg of the third stackable base. For example, a primary axis of each first leg may be substantially aligned in plan view, although each first leg is only partially under the first leg of the adjacent base since the legs are offset by the spacing between the primary axes of the stems. However the primary axis of each first leg may be offset in plan view, for example if the width of the first and third legs is different to the offset between the first and third legs of a base, or if the bases are not tightly packed in perfect alignment (as the design typically includes lateral clearances between a leg and the mating adjacent base).

Alternatively, when horizontally stacked, the respective first or third legs of the first, second and third stackable bases may be arranged side-by-side. For example, an inner edge of one first leg may be adjacent an outer edge of the first leg of an adjacent base.

The horizontally stackable base may be provided as a kit of parts, or brought together with the stem and/or the object to be supported (e.g. table top) as a kit of parts.

The invention will be more readily understood from the following description of a number of specific constructions of stackable base incorporating one or more features of the invention, and as illustrated in the accompanying drawings.

Other arrangements or embodiments are possible, so the provision of the accompanying drawings and the following description thereof should not be taken to limit the scope of the above description of the invention.

### BRIEF DESCRIPTION OF THE DRAWINGS

In the drawings:

FIG. 1 is a perspective view of a first possible base according to the present invention.

FIG. 2 is a perspective view with hidden lines of two horizontally stacked bases of the type shown in FIG. 1.

FIG. 3 is a plan view with hidden lines of six horizontally stacked bases of the type shown in FIG. 1.

FIG. 4 is a side view with hidden lines of the arrangement of FIG. 3.

FIG. 5 is a perspective view of the arrangement of FIG. 3.

FIG. 6 is a perspective view of a second possible base according to the present invention.

FIG. 7 is a perspective view of two horizontally stacked bases of the type shown in FIG. 6.

FIG. 8 is a plan view of the arrangement shown in FIG. 7.

FIG. 9 is a side view of the arrangement shown in FIG. 7.

FIG. 10 is a perspective view of a third possible base according to the present invention.

FIG. 11 is a perspective view of two horizontally stacked bases of the type shown in FIG. 10.

FIGS. 12 and 13 are perspective views of a table utilising a base of the type shown in FIG. 10.

FIG. 14 is a side view of three horizontally stacked tables of the type shown in FIGS. 12 and 13.

FIG. 15 is a front view projected from FIG. 14.

FIG. 16 shows a sign or music stand incorporating the base from FIG. 10.

FIG. 17 shows a medical equipment stand incorporating the base from FIG. 10.

FIGS. 18 and 19 are perspective views of a fourth possible base according to the present invention.

FIGS. 20 and 21 are perspective views of two horizontally stacked bases of the type shown in FIGS. 18 and 19.

FIG. 22 is a perspective view of a fifth possible base according to the present invention.

FIG. 23 is a perspective view of two horizontally stacked bases of the type shown in FIG. 22.

FIGS. 24 and 25 are respectively a perspective view and a plan view of three horizontally stacked tables using bases of the type shown in FIGS. 22 and 23.

FIGS. 26 and 27 are perspective views of a sixth possible base according to the present invention.

FIGS. 28 and 29 are perspective views of two horizontally stacked bases of the type shown in FIGS. 26 and 27.

FIGS. 30 and 31 are respectively a perspective view and an underside view of two horizontally stacked tables using bases similar to the type shown in FIGS. 26 to 29.

FIGS. 32 and 33 are respectively a perspective view and a plan view of three horizontally stacked tables of the type shown in FIGS. 30 and 31.

### DESCRIPTION OF REFERRED EMBODIMENT

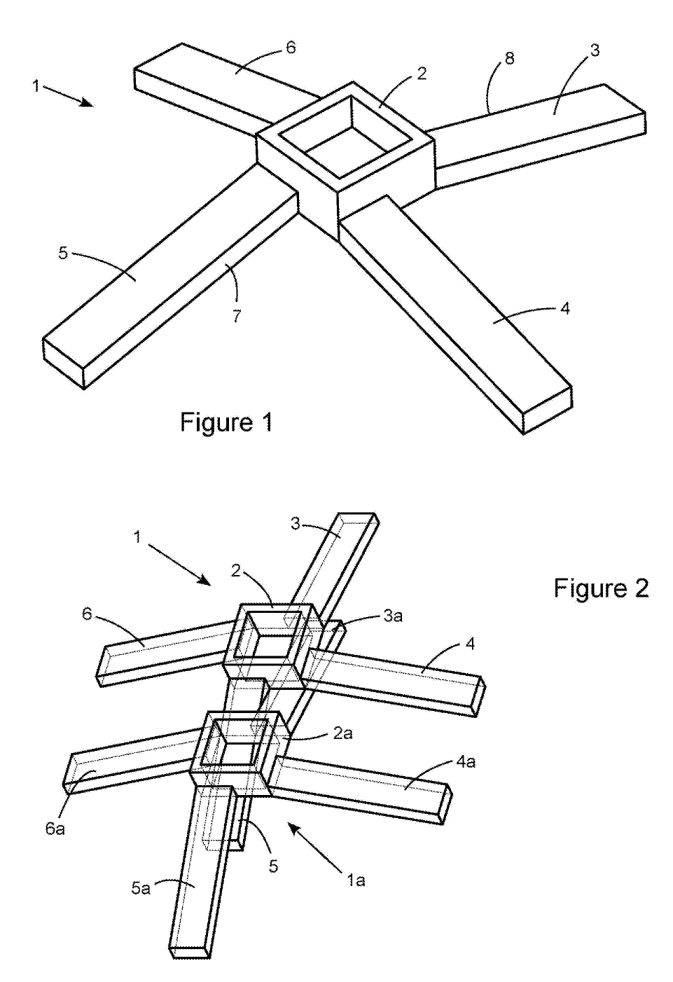

Referring initially to FIG. 1 there is shown a stackable base 1 for supporting an object (not shown) via a hub 2. The base 1 has four legs 3, 4, 5, 6 extending from the hub 2, each leg being perpendicular in plan view to the two adjacent legs. Each leg is also offset from the leg on the opposite side of the hub, in this case by the width of the leg so that the inner edge 7 of leg 5 is substantially aligned with the inner edge 7 of leg 3. Each leg is also angled downwards as it projects from the hub, in this example at 15 degrees from horizontal. This construction allows two such bases 1 and 1a to be horizontally stacked as shown in FIG. 2. Throughout the drawings, similar or equivalent components and features have been given like reference numerals.

In the present specification, the word ‘horizontal’ or the like is not to be taken as limiting to parallel to the ground when referring to the base, since the base may be moved or packaged in an orientation where the ground engaging portions are not lying in plane substantially parallel to the ground. Similarly the word vertical or the like is not to be taken as limiting but as perpendicular to a base plane that is a virtual plane passing through the ground engaging portions (such as feet) of each leg of the horizontally stackable base.

Hidden lines are shown in FIG. 2 to clarify how the two bases nest together in this horizontal stacking arrangement. The leg 3 is substantially aligned with the corresponding leg 3a of the second base 1a if viewed from above, and the legs 5 and 5a on the opposite side of the hub 2 are therefore similarly aligned if viewed from above. So leg 3 of base 1 is above leg 3a of base 1a, at least in part as the bases are horizontally offset from one another, with a length from the distal end of leg 3a being under the hub 2 of base 1 as well as under a portion of leg 3. Similarly leg 5 of base 1 is under leg 5a of base 1a, again at least in part, with a length from the distal end of leg 5 being under the hub 2a of base 1a as well as under a portion of leg 5. As the second base 1a is moved horizontally into the stacked position the top of leg 3a eventually interferes with the hub 2 and this limits the minimum horizontal offset between the adjacent bases when horizontally stacked, i.e. the stacking density. In this case, the length from the distal end of leg 3a to the position on the top of leg 3a that interferes with the hub 2 can be referred to as a stackable profile portion, i.e. the portion of the leg that is lower than the hub of the horizontally stackable base.

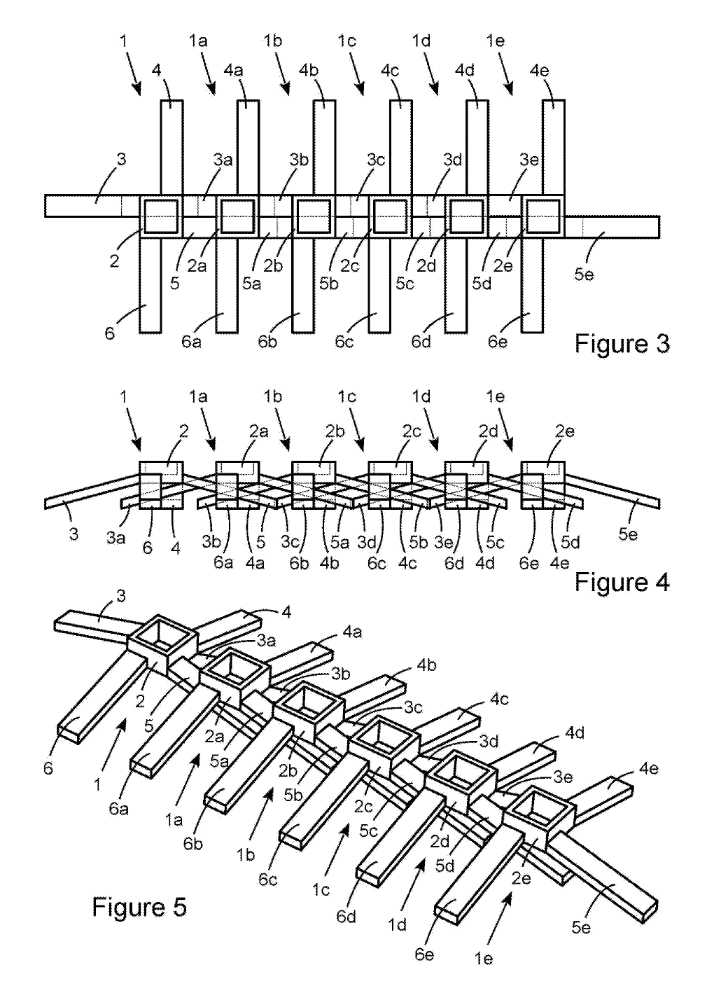

As shown by the horizontal stacking of six similar bases in FIGS. 3, 4 and 5, any number of bases can be horizontally stacked together, providing excellent stacking density.

In FIGS. 3, 4 and 5, the method by which the bases can be horizontally stacked is further explained. Each leg of a base is offset to the right of the hub when looking from the hub towards the respective leg, the base having 4-fold rotational symmetry. Therefore when stacking the bases, leg 3a of base 1a must be to the right of leg 5 of base 1. When base 1a is then moved into the stacked position next to base 1, part of the hub 2a and leg 5a of base 1a pass over part of the leg 5 of base 1. With further horizontal stacking of additional bases this pattern continues. For example, in FIGS. 3, 4 and 5, legs 3a, 3b, 3c, 3d and 3e pass under hubs 2, 2a, 2b, 2c and 2d respectively and under part of legs 3, 3a, 3b, 3c and 3d respectively. The legs 3, 3a, 3b, 3c, 3d and 3e are all substantially parallel to each other as can be seen in the side view FIG. 4. Similarly the hubs 2a, 2b, 2c, 2d and 2e and the legs 5a, 5b, 5c, 5d, and 5e partially pass over (or end up positioned partially above) the legs 5, 5a, 5b, 5c and 5d respectively and the legs 5, 5a, 5b, 5c, 5d and 5e are all substantially parallel when stacked, but offset from one another in at least one horizontal direction. The legs 3, 3a, 3b, 3c, 3d and 3e (or 5, 5a, 5b, 5c, 5d, and 5e) do not all need to be perfectly aligned in plan view although the amount of deviation from the aligned position shown is dependent on the density of stacking required and the clearance designed into the leg and hub geometry of each base. The other legs of each base (3, 4, 4a, 4b, 4c, 4d, 4e, 5e, 6, 6a, 6b, 6c, 6d and 6e) do not have any legs passing above them, although all but 4e and 6 pass over parts of other legs.

To permit closer, more dense, horizontal stacking, the top outer edge of the legs can be shaped to sweep downwards to increase the clearance to the perpendicular leg of an adjacent base of similar design, particularly where the perpendicular leg of the adjacent base is joined to or formed into or portion of the underside of the hub of that adjacent base. Similarly the lower edge of the hub and where present, a portion of a leg formed into the hub can be cut away or shaped to increase the clearance to the top surface of a leg of an adjacently stacked base.

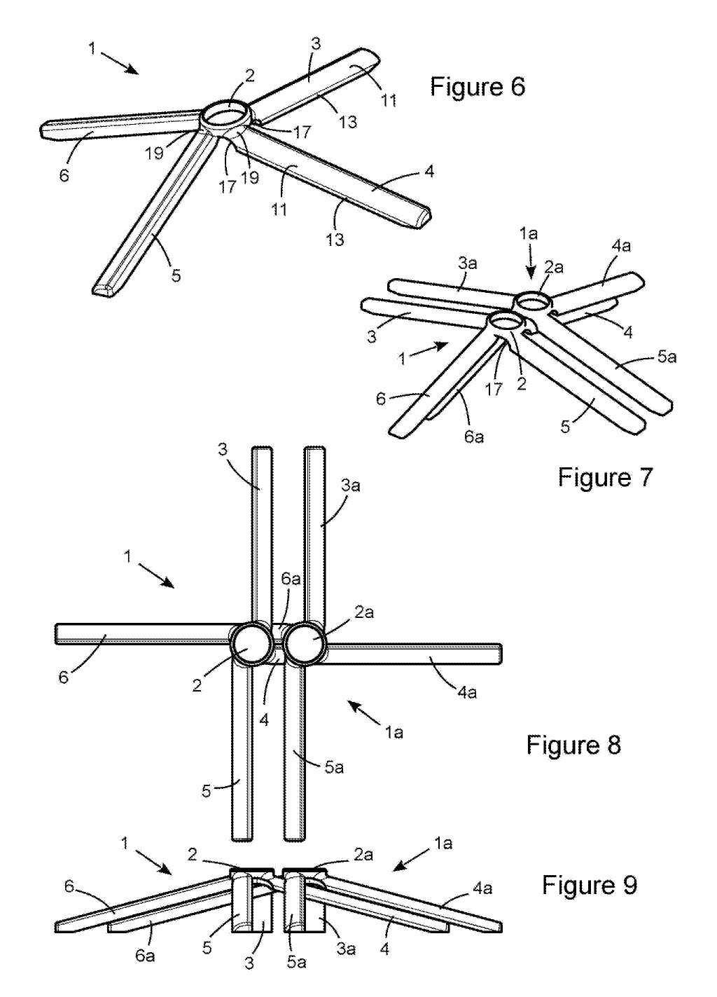

The base shown in FIG. 6 has both of these features and to enable the contours of the legs to be seen, the edges between tangential surfaces are shown by narrower thickness lines compared to the thick lines showing the outline and edges of the base. The base is of a similar layout to the base shown in the previous figures and has similar 4-fold rotational symmetry. Each leg 3, 4, 5 or 6 extends outward from the hub offset to the right when viewed from the hub.

The legs could alternatively be offset to the left, however only bases of left-hand construction can stack most efficiently with other bases of common (i.e. like or similar) left hand construction and conversely only bases of right-hand construction can stack most efficiently with other bases of common right hand construction. The top surface of each leg has a curved surface 11 reducing the height of the outer edge 13 of the leg. The hub 2 is cut-away or has leg clearance shaping 17 to permit the leg of an adjacent horizontally stacked base to be accommodated as the stacking spacing is reduced (i.e. it can permit higher stacking density). Although in this example the leg clearance shaping 17 has also cut into the profile of the perpendicular leg (as can be seen on legs 3 and 4), the cut 17 is angled parallel to the opposite leg so it greatest at the outer edge 13 of each leg. To reinforce the area between each leg and the hub a radius or fillet 19 can be provided as shown.

FIGS. 7, 8 and 9 show two horizontally stacked bases of the type shown in FIG. 6. The provision of the leg clearance shaping 17 allows leg 4 to clear the hub 2a and leg 5a of base 1a allowing bases 1 and 1a to be horizontally stacked more closely than the base type shown in FIGS. 1 to 5.

An alternative to cutting away and reinforcing part of the leg near the hub (or where the leg is formed into the hub) to allow close stacking is to shape the legs to provide the required functionality of clearance whilst closely stacked, while also providing the strength and aesthetic form required.

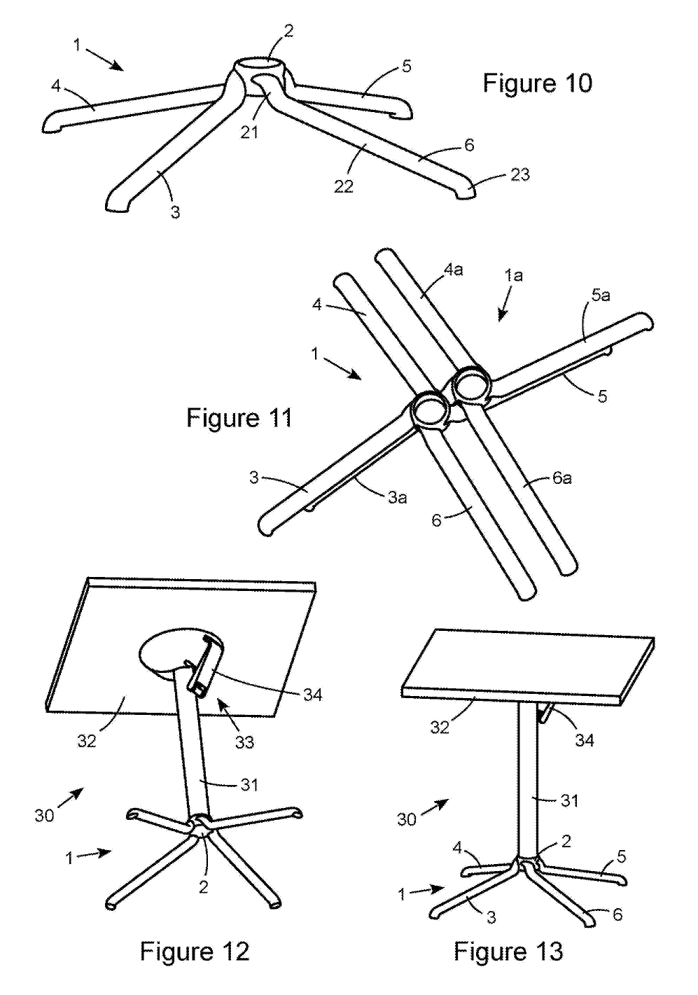

FIG. 10 shows an example of a base of this type where instead of using a leg clearance cut-away and reinforcing fillet, the (and for rotational symmetry, each) leg has a clearance angle portion 21 between the primary portion of the leg 22 (which follows the primary axis line of the preceding examples) and the hub 2. At the distal end of the primary portion of the leg is a ground engaging or foot portion 23, but all portions of the leg can be formed from a single tube if required, or alternatively cast or forged with the hub and the other three legs in one piece. When stacked, the primary portion of the first or third leg 3a or 5 pass under the hub and similar leg of the adjacent base, the primary portion therefore being a stackable profile portion. Also when stacked, a portion at the hub end of the stackable profile portion is above (and therefore higher than) the distal end portion of the stackable profile portion of the similar leg of an adjacent base.

As shown in FIG. 11, the base type shown in FIG. 10 can be closely horizontally stacked. The applications of such horizontally stacking bases are shown in FIGS. 12 to 17.

As shown in FIGS. 12 to 15, the base 1 can be used with a stem 31 and folding table top 32 to form a pedestal type table 30 able to be horizontally stacked at high density.

FIGS. 12 and 13 show the table 30 in its operating position with the table top 32 substantially horizontal or perpendicular to the stem 31 which is in turn fixed to the base 1.

FIG. 12 is a perspective view from under the table 30 to show the folding mechanism 33 which typically incorporates some form of self-locking latch 34 that can easily be released to allow folding and unfolding of the table top 32.

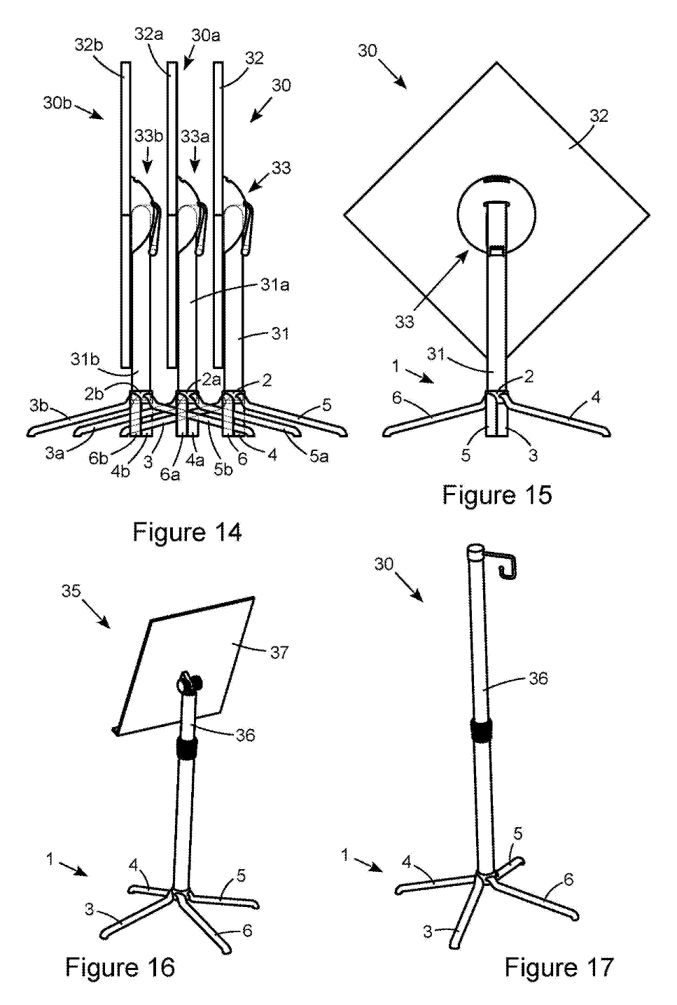

FIGS. 14 and 15 show the table 30 with the top 32 in the more upright storage position. As be seen from the side view of FIG. 14, the tables 30, 30a and 30b can be closely horizontally stacked, in this example, the thickness of the table tops 32, 32a and 32b and folding mechanism 33, 33a and 33b and the diameter of the stems 31, 31a and 31b are the factors limiting stacking density (how close together the tables can be stacked), rather than the geometry of the legs and hub of each base.

FIG. 16 shows the base 1 from FIGS. 10-15 used as a sign stand 35 with an adjustable height stem or post 36 supporting a temporary sign 37, although other similar applications such as supporting a music book holder are also envisaged.

FIG. 17 shows another application of the base, in this case as a medical IV stand 38, although other similar applications such as hat stands are also envisaged.

In many applications, the object being supported limits the possible orientations in which the bases can be closely horizontally stacked. For example, with the table top 32 of FIGS. 12 to 15 and the sign holder 36 of FIG. 16 the bases can only be stacked with the table top or sign surfaces all either facing each other or facing in the same direction (i.e. for horizontal stacking they cannot be perpendicular to each other) so the bases only need to accommodate stacking in two orientations separated by 180 degrees. Typically for the most efficient horizontal stacking all objects would be facing the same way, so the bases could optionally accommodate horizontal stacking in only one direction.

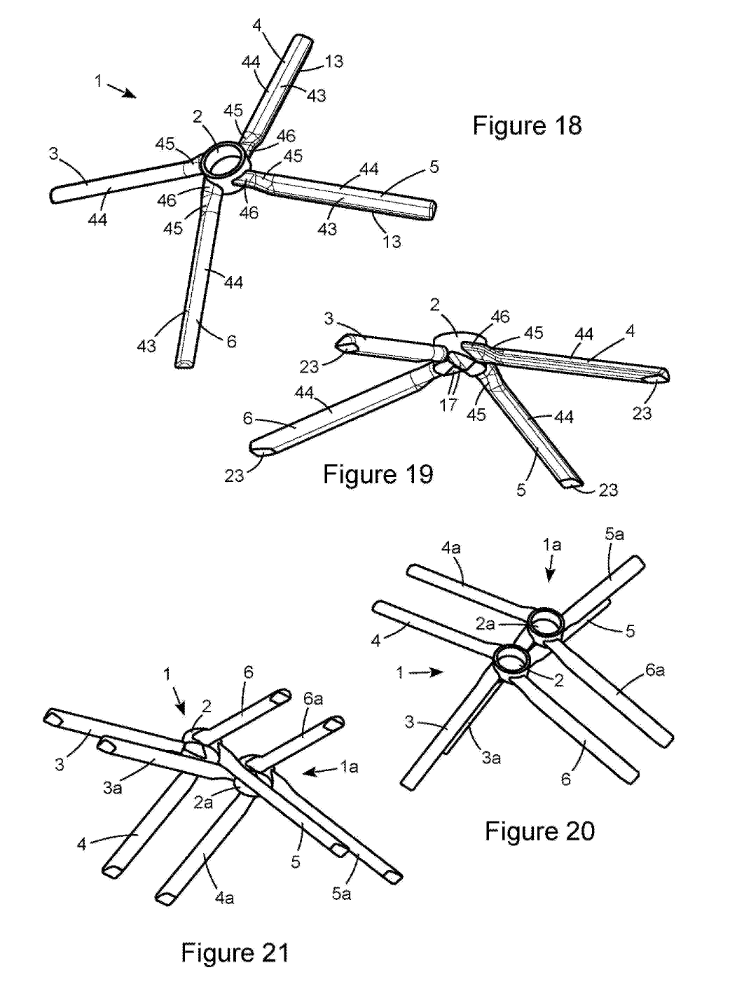

FIG. 18 shows one such design of base having only two-fold rotational symmetry, although for aesthetic reasons or for ease of assembly (i.e. due to having the same functionality for all four sides making it easy to align the mechanism of a folding table top), the legs, from above at least can have four-fold rotational symmetry.

FIG. 19 shows a view from below the plane of the four feet, allowing the two-fold rotational symmetry of the hub to be seen, the main feature of interest being the two angled cut-outs 17 under the hub to provide clearance to the legs of adjacent stacking bases. The stackable profile portion of each of legs 3 and 5 has a top surface that is lower than at least a region (i.e. the relevant clearance profile of each cut out) of the hub.

Additionally FIGS. 18 and 19 show the blend points between different surfaces in light-weight lines to enable the contouring of the legs in particular to be seen. Each leg has a cross-section that narrows towards the outside edge 13 due to a shallow-angled chamfer 43 on the primary portion 44 of the leg. The leg can then have a shape that is twisted over a short portion 45 to the clearance angled portion 46 of the leg which has a flat top side and a chamfer on the underside that clears the top of the leg of an adjacent horizontally stacked base. If the legs each angle downwards at for example 10 degrees as they radiate from the hub 2 to the respective foot (or ground engaging portion) 23, then the chamfer angle under the clearance angled portion 46 of the leg can be 10 degrees. This has the advantage that the width of the legs around the area between the short twisted portion 45 and the primary portion 44 does not need to be restricted in width to fitting under the hub alone when stacked, and also the gradual reduction in the angle of the chamfer under the leg through the short twisted length 45 can guide a leg of a second base towards the similar leg of the first base during stacking.

FIGS. 20 and 21 show a first and second such base horizontally stacked, with the blend lines between surfaces omitted.

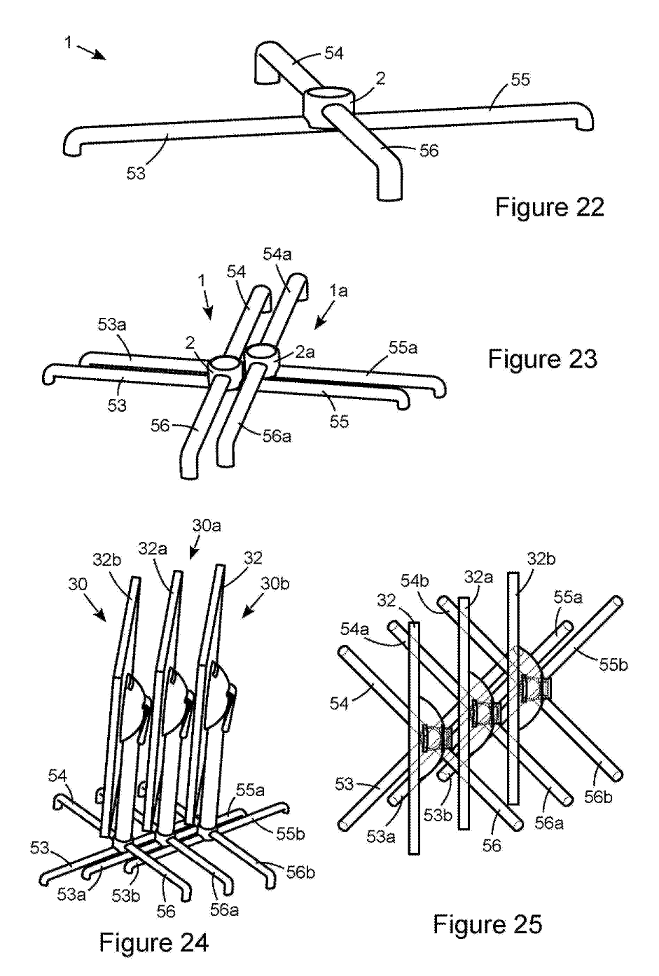

FIG. 22 shows an alternative form of stackable base 1 having two-fold rotational symmetry. In this case the legs are arranged in opposite pairs, the two legs 53 and 55 able to pass under adjacent bases are lower than the other two legs 54 and 56. However, unlike previous arrangements, the two lower legs 53 and 55 are in line with each other and similarly the two higher legs 54 and 56 are also in line with each other on opposing sides of the hub 2.

As shown in FIG. 23, the lower legs 53a and 55 pass under the higher legs 54 and 56a respectively as the two bases are horizontally stacked. However the lower legs which pass under the adjacent stacked base(s) do not in this example sit even partially underneath the similar legs of adjacent bases, instead sitting alongside the similar legs. For example 53 and 53a are adjacent each other when stacked, but would not overlap in plan view.

The bases could be stacked with the lower legs 53a and 55a on the opposite side of the lower legs 53 and 55 of the adjacent base. If wide legs and/or close stacking is required, the hubs can be shaped above the connection of the lower legs to the hub to clear the higher legs of adjacent stacked bases, or more preferably, the lower edges of the hubs 2 and 2a can be shaped to clear the lower legs of adjacent stacked bases.

Generally, the objects being supported, such as the folding table tops 32, 32a and 32b in FIGS. 24 and 25 require a larger spacing between adjacent bases than the bases themselves require. This provides a range of possible spacings between the upper legs of adjacent bases and the lower legs of adjacent bases. In the example shown in FIG. 24, more clearly viewed from above in FIG. 25, the lower legs 53, 53a, 53b and 55, 55a, 55b are relatively close together and the spacing between the higher legs 54, 54a, 54b and 56, 56a, 56b is large.

Although the tables can be stacked with the reverse being true (the lower legs of each base having a large space to the lower legs of the adjacent base and the higher legs being close together) or anywhere in-between, the horizontal stacking works best as shown in FIGS. 24 and 25, so the legs may all be angled downwards to encourage this stacking formation.

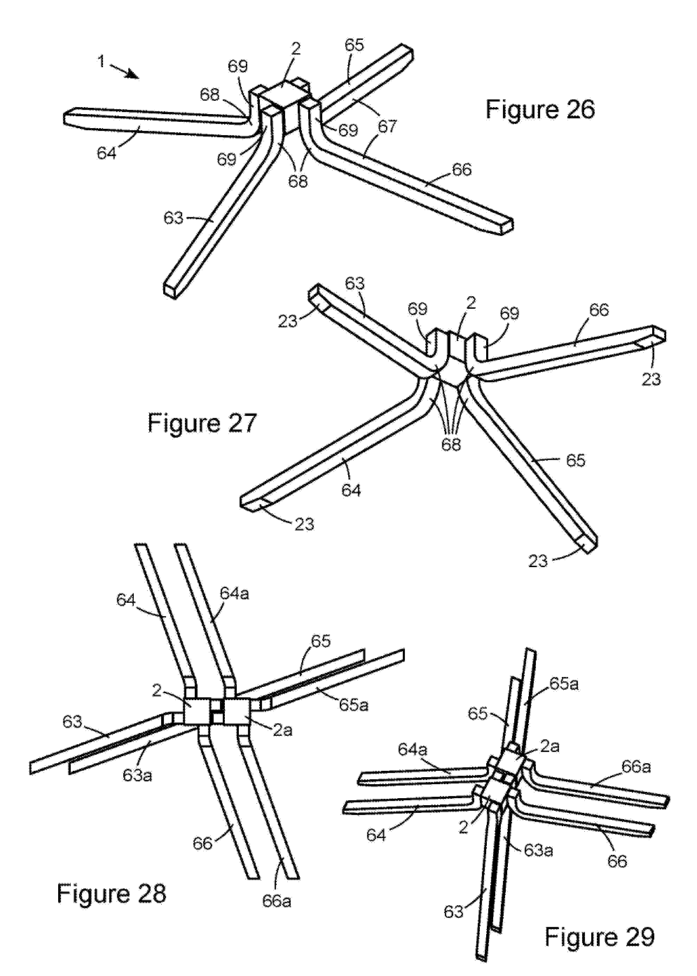

FIGS. 26 to 29 show another variation of stackable base in which the legs which pass under the adjacent base when stacked sit side by side with the similar legs of the adjacent base. However, in this case the base has four-fold rotational symmetry as all the legs are similar.

As can be seen in FIG. 28, the similar legs of adjacent bases do not overlap in plan view.

Referring to FIGS. 26 and 27, each leg 63, 64, 65 and 66 has a primary portion 67, the hub end of which blends into a curved clearance portion 68 which in turn ends in a more upright portion 69 fixed to the hub.

The primary portion of each leg is offset from the leg on the opposite side of the hub, so although they are parallel they are not in line. For example, the primary portion 67 of leg 63 is parallel to the primary portion 67 of leg 65, but they are not in line. In fact, in the example shown, the curved clearance portion of each leg is not only curved in a side view of the leg, but in plan view also.

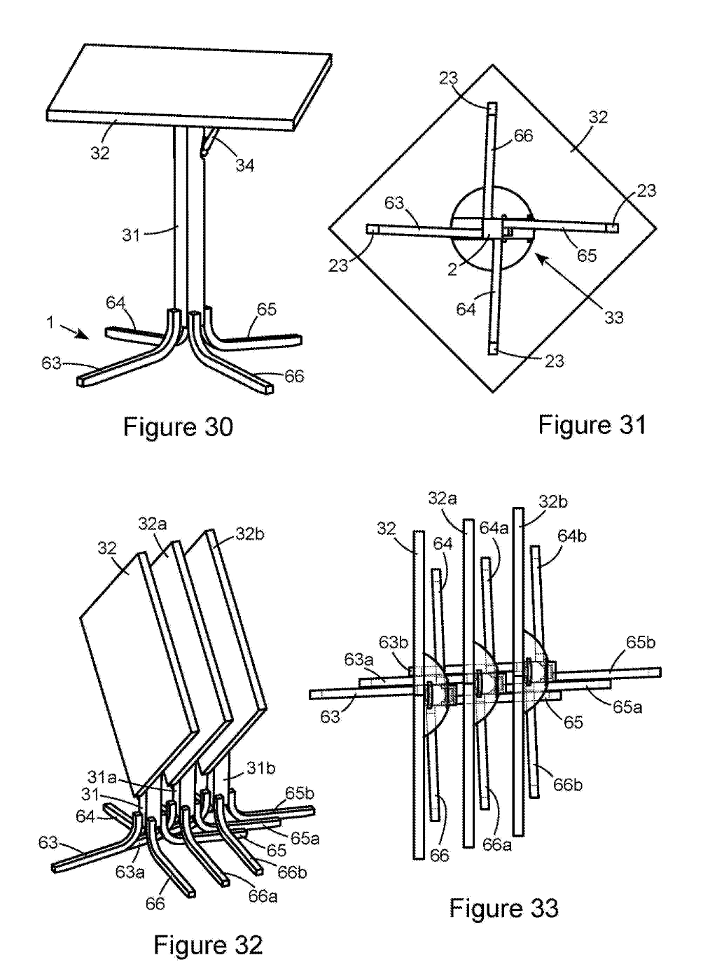

As shown in FIGS. 28 and 29, when horizontally stacked, the leg 63a passes partially under the hub 2 and partially under the curved clearance portion 68 of leg 66. Similarly leg 65 passes partially under the hub 2a and partially under the curved clearance portion 68 of leg 64a. This style of base is most suited to supporting round or uneven shaped objects as the square formed by the position of the ground engaging or foot portion of each leg (i.e. the footprint) is not aligned with or at 45 degrees to the hub 2. For example, for support of a square table top, the square formed by the position of the feet should preferably be aligned with the square table top for maximum stability and to avoid the need for people to straddle a leg when seated at such a table. However the base of FIGS. 26 to 29 can be adapted to suit table tops for example, as shown in FIGS. 30 to 33.

The folding table top 32 in FIG. 30 is shown in its operating position on a base of a similar style to FIG. 26, but as can be seen in the underside view of FIG. 31, the legs 63, 64, 65, and 66 are angled such that the position of the feet 23 form a square (footprint) aligned with the square table top 32 and at 45 degrees to the hub 2. Opposite legs (63 and 65, or 64 and 66) are parallel to each other, but again have their primary portions offset.

As shown in FIG. 32, the tables (when the table tops are in the stored position) stack horizontally, with the stack spacing being limited (as in FIGS. 14 and 24) by the table top, folding mechanism and stem dimensions rather than the base geometry.

FIG. 33 shows the horizontal stack of tables from 32, now in plan view to illustrate that the slight angle of the legs (required to give the perfect alignment of footprint with table top when the table top is in the operating position) results in a slight angle between the plane of the folded table tops 32, 32a, 32b and the legs 64 and 66, 64a and 66a, 64b and 66b.

A number of modifications and variations to the invention have been disclosed above to illustrate that any further modifications and variations as would be apparent to a skilled addressee are deemed to be within the scope of the present invention.

1. A horizontally stackable base to support an object, the base comprising: a hub connected to the object to be supported, four legs extending from the hub, each leg including a ground engaging portion, the four legs being a first, second, third and fourth leg, the first and third legs being on opposing sides of the hub and substantially perpendicular to the second and fourth legs, wherein the stackable base includes a leg geometry such that, when a first and second said stackable base are horizontally stacked, the first leg of the second stackable base passes under at least a portion of the hub of the first stackable base and the third leg of the first stackable base passes under at least a portion of the hub of the second stackable base.

2. A horizontally stackable base according to claim 1 wherein when a first and a second said stackable base are horizontally stacked the first leg of the second stackable base is partially under the first leg of the first stackable base, and the third leg of the first stackable base is partially under the third leg of the second stackable base.

3. A horizontally stackable base as claimed in claim 2 wherein each leg has a primary axis, the primary axis of the first and third legs being offset by at least a width of a portion of the first or third leg.

4. A horizontally stackable base as claimed in claim 3 where each leg is angled such that when multiple of said horizontally stackable bases are horizontally stacked, an upper surface of the first leg of one base is under a lower surface of the first leg of the adjacent base and an upper surface of the third leg of one base is under a lower surface of the third leg of another adjacent base.

5. A horizontally stackable base according to claim 1 wherein when the first and second of said stackable base are horizontally stacked the first legs of the first and second stackable bases are arranged side-by-side, and the third legs of the first and second stackable bases are arranged side-by-side.

6. A horizontally stackable base according to claim 1 wherein each leg has a primary axis, the primary axis of the first and third legs being offset by at least a width of a portion of the first or third leg.

7. A horizontally stackable base according to claim 1 wherein the hub has a virtual axis extending substantially perpendicular to a base plane and passing through the centre of the hub, the base plane being a virtual plane passing through the ground engaging portion of each leg of the horizontally stackable base, the four legs having rotational symmetry about said virtual axis.

8. A horizontally stackable base as claimed in claim 7 where at least one pair of opposing legs comprises one leg parallel with another leg, the one leg and the another leg being offset from the centre of the hub and from each other.

9. A horizontally stackable base according to claim 1 wherein the object is a table top connected to the hub by a stem, the table top being foldable relative to the stem between an operating position and a stacking or storing position.

10. A horizontally stackable base as claimed in claim 9 wherein a hub centre virtual axis extends through the centre of the hub perpendicular to a base plane, the base plane being a virtual plane passing through the ground engaging portion of each leg of the horizontally stackable base, the stem has a major axis, the major axis of the stem being aligned with the hub centre virtual axis.

11. A horizontally stackable base according to claim 1 wherein the object is a stand.

12. A horizontally stackable base to support an object above four legs, the stackable base including the four legs extending from a hub, the hub to be connected by a stem to the object to be supported, each leg including a ground engaging portion, the four legs being a first, second, third and fourth leg, the first and third legs being on opposite side of the hub and substantially perpendicular to the second and fourth legs, wherein at least the first and third legs each include a stackable profile portion extending a distance from the distal end of the respective leg, the stackable profile portion having a top surface lower than at least a region of the hub, such that when a first, a second and a third of said stackable bases are horizontally stacked, the stackable profile portion of the first leg of the second stackable base passes under the hub of the first stackable base, and the stackable profile portion of the third leg of the second stackable base passes under the hub of the third stackable base.

13. A horizontally stackable base as claimed in claim 12 wherein when horizontally stacked, the first leg of the second stackable base is partially under the first leg of the first stackable base and partially above the first leg of the third stackable base and the third leg of the second stackable base is partially above the third leg of the first stackable base and partially under the third leg of the third stackable base.

14. A horizontally stackable base as claimed in claim 12 wherein, when horizontally stacked, the respective first or third legs of the first second and third stackable bases are arranged side-by-side.
